(19) United States
(12) Patent Application Publication
(10) Pub. No.: US 2003/0077969 A1
(43) Pub. Date: Apr. 24, 2003

(54) Sound absorption material having excellent moldability

(75) Inventor: Shigeki Tanaka, Osaka (JP)

Correspondence Address: FOLEY AND LARDNER, SUITE 500, 3000 K STREET NW, WASHINGTON, DC, 20007, US

(73) Assignee: TOYO BOSEKI KABUSHIKI KAISHA

(21) Appl. No.: 10/233,622

(22) Filed: Sep. 4, 2002

(30) Foreign Application Priority Data
Sep. 6, 2001 (JP) 2001-270796

(51) Int. Cl. D04H 1/00; D04H 3/00; D04H 5/00; D04H 13/00; B32B 5/26; B32B 5/18; B32B 5/24

(52) U.S. Cl. 442/334; 428/292.1; 442/340; 442/341; 442/381; 442/370; 442/345

(57) ABSTRACT

A sound absorption material excellent in moldability, wherein a filament nonwoven fabric (A) having a weight of 20 to 200 g/m² and including fiber having a fiber diameter of not more than 15 μm and a staple fiber nonwoven fabric (B) having a weight of 50 to 2000 g/m² and a fiber diameter of 7 to 40 μm are laminated and integrated, and 5 to 50% by mass of the staple fiber nonwoven fabric (B) is a thermally adhesive fiber having a melting point of 100 to 190° C.

### BACKGROUND OF THE INVENTION

1. Field of the Invention

The present invention relates to a sound absorption material excellent in sound absorption property and vibration suppression characteristics. Particularly, it relates to a sound absorption material having an outstanding moldability, which clearly forms irregularities according to a mold even if there is a large strain in a drawing part at the time of molding.

2. Prior Art

As a sound absorption material for automobile and construction and the like, a staple fiber nonwoven fabric has been used widely, and in order to increase sound, absorption performance, a method of using a fiber having a finer fiber diameter to increase the passage resistance of air, or of making weight heavier has been adopted. Consequently, when high sound absorption performance is required, a thick and heavy staple fiber nonwoven fabric made of a comparatively fine fiber having a fiber diameter of approximately 15 μm and having a weight of 500 to 5000 g/cm² is used. Since a nonwoven fabric including super fine fiber is comparatively excellent in characteristics, such as sound absorption characteristic, filtering property, and covering property, it has been used in many applications. There are problems, however, that it has a low strength and a poor form stability, and therefore it is often used in a state being integrated by lamination with another nonwoven fabric in order to improve the disadvantages. However, there proved to be another problems that a bonding strength in the interface of laminated nonwoven fabrics is poor, and that therefore interlaminar peeling inside the super fine fiber nonwoven fabric is easily caused.

On the other hand, a method of carrying out lamination and integration of a super fine fiber nonwoven fabric and a filament nonwoven fabric is known as a common name of S/M/S and the like. In this method, a melt blown nonwoven fabric M that is made of a super fine fiber is laminated between spunbond nonwoven fabrics S, and the resulting laminate is joined by a heat embossing method. However, in these nonwoven fabrics, there have been problems that they are poor in bulkiness, have hard feeling and poor moldability. Also, a nonwoven fabric called COFORM in which a staple fiber having a fiber diameter of around 20 to 30 μm is blown and integrated inside a melt blown nonwoven fabric has been also commercialized, which shows an outstanding sound absorption performance, but shows an inadequate mechanical property, or a poor moldability. Furthermore, in sound absorption material built into automobile interior material, electric appliance, and the like, three-dimensional molding is often performed. However, there has been a problem that a nonwoven fabric including super fine fiber, when subjected to deep drawing molding, can not follow a large strain in the deep drawing portion, resulting in the rupture of the nonwoven fabric.

### SUMMARY OF THE INVENTION

The present invention aims at providing a sound absorption material that has high sound absorption performance and that has excellent moldability at a low price. Especially the present invention aims at providing a sound absorption material having an excellent moldability that is not ruptured even by a large strain in a drawing portion at the time of molding.

In order to solve the above aim, the present invention adopts the following aspects:

The first aspect of the present invention is a sound absorption material excellent in moldability, where in a filament nonwoven fabric (A) having a weight of 20 to 200 g/m² and including fiber having a fiber diameter of not more than 15 μm and a staple fiber nonwoven fabric (B) having a weight of 50 to 2000 g/m² and a fiber diameter of 7 to 40 μm are laminated and integrated, and 5 to 50% by mass of the staple fiber nonwoven fabric (B) is a thermally adhesive fiber having a melting point of 100 to 190° C.

The second aspect of the present invention is the sound absorption material excellent in moldability according to the first aspect of the present invention, wherein a fiber diameter of the fiber constituting the filament nonwoven fabric (A) is not more than 10 μm.

The third aspect of the present invention is the sound absorption material excellent in moldability according to the first aspect of the present invention, wherein the fiber constituting the filament nonwoven fabric (A) is a super fine fiber, a fiber diameter of which is not more than 6 μm.

The fourth aspect of the present invention is the sound absorption material excellent in moldability according to any one of the first to third aspects of the present invention, wherein material of the filament nonwoven fabric (A) is a thermoplastic elastomer.

The fifth aspect of the present invention is the sound absorption material excellent in moldability according to any one of the first to fourth aspects of the present invention, wherein a packing density of the staple fiber nonwoven fabric (B) is 0.005 to 0.3 g/cm³.

The sixth aspect of the present invention is the sound absorption material excellent in moldability according to any one of the first to fifth aspects of the present invention, wherein the staple fiber nonwoven fabric (B) is prelaminated to the filament nonwoven fabric (A) by a needle punch method, and integrated by an air through method.

The seventh aspect of the present invention is the sound absorption material excellent in moldability according to any one of the first to sixth aspects of the present invention, wherein a penetration of needling is 5 to 15 mm, and a punching density is 30 to 200 perforations/cm².

The eighth aspect of the present invention is the sound absorption material excellent in moldability according to any one of the first to seventh aspects of the present invention, wherein a breaking elongation is not less than 25%.

The ninth aspect of the present invention is the sound absorption material excellent in moldability according to any one of the first to eighth aspects of the present invention, wherein a filament nonwoven fabric (c) having a fiber diameter of 5 to 20 μm and a weight of 20 to 250 g/m² is laminated to at least one side of the sound absorption material.

The tenth aspect of the present invention is the sound absorption material excellent in moldability according to any one of the first to eighth aspects of the present invention, wherein a foam consisting of polyolefin or polyester is laminated to at least one side of the sound absorption material.

The eleventh aspect of the present invention is the sound absorption material excellent in moldability according to the tenth aspect of the present invention, wherein Frazier air permeability of the foam is not more than 6 cc/cm²·sec.

The twelfth aspect of the present invention is the sound absorption material excellent in moldability according to any one of the first to eleventh aspects of the present invention, wherein a deep-drawing local strain is 40% or more.

The thirteenth aspect of the present invention is the sound absorption material excellent in moldability according to any one of the first to twelfth aspects of the present invention, wherein the sound absorption material is interior material for vehicles.

### DETAILED DESCRIPTION

The present invention will be described in detail below.

It is preferable that a filament nonwoven fabric (A) includes not less than 10% by mass of a fiber having a fiber diameter of not more than 15 μm. A fiber diameter of the fiber consisting the filament nonwoven fabric is preferably not more than 10 μm and more preferably not more than 6 μm (super fine fiber). The whole nonwoven fabric may comprise only the super fine fiber. However, if content of the super fine fiber is too small, effect by super fine fiber characteristics will be hard to be obtained. When using super fine fiber, it is possible to produce a sound absorption material excellent in sound absorption property in spite of being lightweight and thin. A fiber diameter of the super fine fiber is preferably not more than 6 μm, and more preferably 0.5 μm to 4 μm, and most preferably approximately 1.5 m to 3 μm. Incidentally, when the thickness of the laminated nonwoven fabric is more than 15 mm, it is possible to produce a sound absorption material having good sound absorption property even if the fiber constituting of the filament nonwoven fabric has a fiber diameter between 6 μm and 15 μm.

Although a manufacturing method of the filament nonwoven fabric is not especially limited, an especially preferable one is a melt blowing method in which a random arrangement of fiber is obtainable and the production cost is cheap. Since a melt blown nonwoven fabric has a low strength, it is preferable to combine the melt blown nonwoven fabric with a nonwoven fabric for reinforcement, such as spunbond nonwoven fabric, or it is also preferable to laminate nonwoven fabrics by three or more layers simultaneously in the laminating process. In this case, one of preferable embodiments is that a spunbond nonwoven fabric excellent in wear resistance may be arranged on a side which serves as a surface at the time of use.

And, it is also one of preferable embodiments to use a super fine fiber obtained by using a split fiber or an island-sea structure type fiber. Splitting processing of the split fiber to form super fine fiber may be performed beforehand, or it may be simultaneously performed in laminating processing.

A filament nonwoven fabric is preferably a nonwoven fabric having a weight of 20 to 200 g/m². In case a super fine fiber constitutes the filament nonwoven fabric, when a weight becomes smaller than 20 g/m², the outstanding sound absorption effect of the super fine fiber may no longer be demonstrated. On the other hand, when a weight exceeds 200 g/m², a problem of crease generation or of weak bonding force may arise in the case where the filament nonwoven fabric is combined with a staple fiber nonwoven fabric. Also, superfluously large weight does not necessarily serve to increase an effect, such as improvement in sound absorption property, which is not preferable in the light of cost reduction and weight reduction.

Although a material that constitutes the filament nonwoven fabric is not especially limited, for example, it may be a thermoplastic synthetic resin. Preferably, it is a material similar to the staple fiber nonwoven fabric laminated to a filament nonwoven fabric in the light of the easiness of recycling of the material. It is satisfactory even if plural fibers consisting of different material are mixed. When using a super fine fiber made by a melt blowing method, since the fiber is filament type and there is almost no cutting end, it is preferable to use especially a thermoplastic elastomer. As the thermoplastic elastomer, known elastomer, such as polyester, polyamide, polyurethane, and polyolefin, can be used.

And, a fiber constituting the filament nonwoven fabric maybe a sheath core type conjugate fiber. In this case, a sheath component is of a thermoplastic resin having a lower melting point of 110 to 220° C., and a core component is a thermoplastic resin having a higher melting point of 180 to 300° C. Preferable thermoplastic resin having a lower melting point involves known thermally adhesive resin, such as polyolefin based, polyester based, and polyurethane based resin. Preferable thermoplastic resin having a higher melting point involves polyester based resin, such as polyethylene terephthalate, polypropylene terephthalate, polybutylene terephthalate, and polylactic acid.

When laminating of a filament nonwoven fabric or a super fine fiber nonwoven fabric to other nonwoven fabrics by needle punch method, punched pores by needles may sometimes remain, and there occurs a problem that air passes through the pores by channeling and blows out, resulting in the leak of air to impair sound absorption property. However, if a polymer currently used is an elastomer, the pores will be recovered to original size by deformation, which is preferable because the size of pores formed becomes smaller again, and sound absorption property hardly falls. According to examinations by the present inventors, sound absorption performance fell markedly using a super fine fiber consisting of non-elastomer, when punching density was not less than 100 perforations/cm². On the other hand, in the case of elastomer, there was almost no performance decrease in the same punching density, and a peeling strength of the laminated body was made higher by making punching density higher, and thus high form stability was obtained.

When a super fine fiber consisting of a non-elastomer resin is used, punching density is preferably not more than 50 perforations/cm², and more preferably not more than 30 perforations/cm². When the punching density is small, although a problem of decrease in sound absorption property is overcome, there are not few cases where peeling in nonwoven fabric interface poses a problem. To cope with this problem, it is especially preferable that a thermally adhesive fiber is used in a staple fiber nonwoven fabric (B) for lamination, and that a hot air is passed through the nonwoven fabric by air through method after needle punch processing to weld a nonwoven fabric (A) with the nonwoven fabric (B). In this case, it is required to set a melting point of the thermally adhesive fiber to a suitable range so that the non-adhesive fiber may not cause problems, such as shrinking with heat. Since a nonwoven fabric using a super fine fiber has large air flow resistance and hot air cannot be transmitted easily in the case of air through method processing, needle punch processing is given as pretreatment. This pretreatment is especially preferable because it leads not only to improvement in bonding strength (peeling strength) but to improving air through working speed or lowering operation cost of a blower fan. It is difficult to increase a peeling strength enough only by adhesion using the air through method.

Next, in a staple fiber nonwoven fabric (B) laminated with a nonwoven fabric including a super fine fiber, a fiber diameter is preferably between 7 to 40 μm, and more preferably between 7 to 20 μm. Although a fiber diameter finer than 7 μm does not cause a large problem directly, it is not so preferable in respect of productivity, such as spinning property out of a carding machine. Also, a fiber diameter significantly smaller than 7 μm lowers the laminating effect by the present invention. Further, it may cause another problem that the nonwoven fabric tends to become fluffy. On the other hand, a fiber diameter thicker than 40 μm provides small contribution to sound absorption performance.

In the present invention, laminating of a staple fiber nonwoven fabric and a nonwoven fabric including a super fine fiber is carried out for the objective, such as improving the problems of a low form stability of the nonwoven fabric including the super fine fiber (easily worn out or becoming fluffy), and of low bulkiness maintenance property, or as obtaining high cushioning property, and vibration suppression property. It is admitted that a larger thickness of a sound absorption material generally gives a higher performance. In this sence, it is advantageous to perform laminating because the thickness of the sound absorption material increases thereby. A sound absorption material having high sound absorption performance and good form stability may be designed by mixing a fine fiber that contributes to improvement in sound absorption performance, and coarser fiber that contributes to form stability improvement by a suitable percentage.

Preferably, the staple fiber nonwoven fabric has a weight of 50 to 2000 g/m². When the weight is less than 50 g/m², laminating effect to be obtained is small, which is not so preferable in view of bulkiness or soft-feeling of the nonwoven fabric. On the other hand, the weight larger than 2000 g/m² is not preferable because the nonwoven fabric becomes too thick requiring an excessive space, and becomes heavy.

A fiber length of the staple fiber constituting the staple fiber nonwoven is preferably not less than 38 mm and not more than 150 mm, and especially preferably between 50 mm and 150 mm. According to examinations of the present inventors, a longer fiber length gave a better sound absorption property. However, when the fiber length was too long, spinning property out of a carding machine is unpreferably decreased. Although the staple fiber may consist of a single component, it may be a mixture of two or more components and a conjugate fiber including two or more kinds of components. When it is not more than about 30% in mass fraction, even if a coarser fiber is mixed in order to adjust the stiffness of the nonwoven fabric, characteristics scarcely change. If coarser fiber is mixed too much, there easily occurs a problem that nonwoven fabric becomes to demonstrate excessively coarse touch. It is also preferable to use a thermally welding fiber having melting points mutually different from each other in view of improving dimensional stability.

As for a packing density based on mass of a staple fiber nonwoven fabric, it is preferably between 0.005 to 0.3 g/cm³ in the light of bulkiness. Too small packing density unpreferably gives a poor form stability. If a packing density becomes larger than 0.3 g/cm³, sound absorption property will tend to worsen, which will hardly satisfy objective of the present invention.

In the present invention, it is especially preferable that 5 to 50% by mass of a staple fiber nonwoven fabric (B) is thermally adhesive fiber having a melting point of 100-190° C. When a mass of adhesive fiber is less than 5% by mass, it becomes unpreferably difficult to obtain a high peeling strength in nonwoven fabric interface. And, a sound absorption material when molded shows a poor moldability and a sharp molding form is difficult to be obtained. On the other hand, when the thermally adhesive fiber becomes larger than 50% by mass, it is not preferable that not only the cost becomes higher but the nonwoven fabric gives coarse touch, and moreover film is formed in an area where drawing strain of molding is large to lose air permeability, resulting in poor sound absorption performance.

In the laminating integration method of a nonwoven fabric, it is preferable to integrate by a combined use of the needle punch method and the air through method as mentioned above. Each method is carried into effect as a general nonwoven fabric processing method, and is explained in detail in “Foundation of nonwoven fabric and application” by Nonwoven fabric study group of Textile Machinery Society of Japan and the others. It is probably known to integrate nonwoven fabrics using this needle punch method. However, probably because that when a nonwoven fabric having a uniform face with the super fine fiber, and a nonwoven fabric with a bulky, comparatively thick staple fiber are combined with a needle punch machine, punched holes are formed in the super fine fiber nonwoven fabric to decrease sound absorption performance and filtering property and the like, and characteristics of the super fine fiber have been thought difficult to be demonstrated, such article cannot be found in the market.

It is preferable to use a finer needle than No. 38 on the occasion of needle punch processing, and it is especially preferable to use Nos. 40 to 42. Needles are preferably to be inserted from a side of a staple fiber nonwoven fabric, and loops of the staple fiber are formed on the external side of a nonwoven fabric including a super fine fiber. In a nonwoven fabric including the super fine fiber, component fiber may be hooked on other objects, or may be cut by them to easily become fluffy, but loops of the staple fiber prevents the surface fluff of the nonwoven fabric including super fine fiber, or plays a role of cushioning the layer, and thereby external force applied to the super fine fiber nonwoven fabric layer may be mitigated, resulting in the prevention of destruction of the nonwoven fabric.

In addition, when the sound absorption material of the present invention is laminated to another nonwoven fabric, and film, etc. having elongation higher than 25%, a defect that a nonwoven fabric including super fine fiber is destroyed by an external force applied, such as bending or pulling may be prevented by adhering loops of staple fiber and a third material that is laminating partner. In order to form loops of staple fiber having suitable size, depth of needling is preferably not more than 15 mm. When penetration of needling exceeds 15 mm, nonwoven fabric is often destroyed by an impact generated when the needle and the staple fiber pass through the super fine fiber nonwoven fabric, or punched holes after penetrated often becomes excessively large, which is not preferable so much.

Although it is dependent on a position of a barb of a needle, in order to increase the entangling of a nonwoven fabric and to prevent peeling, a depth of needling is preferably not less than 5 mm. A punching density is preferably 30 to 200 perforations/cm². A smaller punching density than 30 perforations/cm² may unpreferably cause a problem of peeling a nonwoven fabric, and a larger density than 200 perforations/cm² will give excessively a large total area of punched holes, or easy tear and rupture of the nonwoven fabric including the super fine fiber. As for the temperature and velocity of air of the air through method, suitable conditions need to be specified in production field, because they are dependent on form of a nonwoven fabric and a working speed. In an air through method, since a nonwoven fabric is inserted by nets etc. to adhere fiber, thickness adjustment of the nonwoven fabric is easily done and it also becomes possible to control variation in sound absorption performance small.

A breaking elongation of a sound absorption material laminated is preferably not less than 25%, and more preferably not less than 50%, and especially preferably not less than 100%. A nonwoven fabric having less than 25% of breaking elongation cannot catch up with the strain at the time of molding to give rupture in super fine fiber layer and the like, and shows a tendency for sound absorption property to fall markedly. Further, if a nonwoven fabric has a high breaking elongation and following property to strain, a problem of cutting formation caused by poor control of stress may easily be avoided also in working processing. A molding temperature may suitably be selected between room temperature and around 200° C.

As a partner material laminated to a sound absorption material according to any one of the first to eighth aspects of the present invention for the purpose of fluff prevention and form stability improvement of a sound absorption material, a filament nonwoven fabric (C) having a fiber diameter of 5 to 20 μm, and a weight of 20 to 250 g/m² is especially preferable.

In this filament nonwoven fabric (C), when a fiber diameter is less than 5 μm, improving effects such as form stability, are insufficiently demonstrated, and when exceeding 20 μm, unevenness of the nonwoven fabric maybe unpreferably recognized. As to weight, in case of below 20 g/m², the unevenness of texture tends to be observed, and even if it is laminated by needle punching, problems of easy peeling may easily occur because of few entangled points of the fiber. On the other hand, a weight exceeding 250 g/m² is in direct conflict with meaning of the present invention aiming at weight reduction. It is preferable that coloring may be given or pattern may be printed on a surface of a nonwoven fabric laminated to demonstrate designing. Thereby, the nonwoven fabric may be visually harmonized with circumference without sense of incongruity as a sound absorption material used for a construction structure, or an automobile interior material. Although material of fiber will not be limited especially as long as it has not less than 25% of elongation, thermoplastic elastomers, and polyester fibers having a rate of birefringence smaller than 0.08 are especially preferable.

It is preferable that a foam consisting of polyolefin or polyester is laminated to at least one side of the sound absorption material according to any one of the first to eighth aspects of the present invention. This is probably because that a frequency that contributes to sound absorption of the foam is different from a case of a sound absorption material consisting of a nonwoven fabric using super fine fiber to demonstrate a reinforce effect. As a material, polyester or polyolefin is preferable from the viewpoint of workability or cost. Further, when the foam is constituted by closed cells, a structure like acoustic resonator is formed in a thickness direction by giving holes with suitable size to the foam using a needle punching machine and the like, and probably by this reason a large sound absorption property may be obtained.

A punching interval is preferably between about 0.5 to 5 mm. Although pores may be made passed through from a surface to a back face of the foam, it may also reach up to middle depth of the foam. It is preferable that punch processing maybe given from both of the surface side and the back side of the foam. A size of pore is preferably about 0.1 to 1 mm.

The Frazier air permeability of the foam after punched is preferably not less than 0.01 cc/cm²·sec and not more than 6 cc/cm²·sec, more preferably not more than 2 cc/cm²·sec, and especially preferably not more than 1 cc/cm²·sec. It is probably possible to set sound absorption property higher by controlling the permeability value smaller. However, when the air permeability is zero, the foam reflects sound wave on its surface. Thus, it is preferable that the air permeability of the foam after punched is not zero. Further, in order to improve sound absorption performance, especially it is preferable to laminate two or more foams. In this case, it is especially preferable to perform adhesion not using a heat welding film without air permeability but using a nonwoven fabric consisting of thermally adhesive fiber with air permeability, or using a thermally adhesive powder, because this method does not impair sound absorption performance. Lamination of the foams with pores may be performed so that they may be adjoined, or they may be adhered on both sides of other nonwoven fabrics and the others.

Further, as one of desirable embodiments, in order to control air permeability etc., laminating of a film having pores to a nonwoven fabric layer including a super fine fiber may. also be mentioned. In addition, it is also preferable to combine the nonwoven fabric with woven textiles depending on usage. Furthermore, a top layer of a nonwoven fabric with design having coloring and patterns given thereon may be attached on the outside of the combined nonwoven fabrics, and these resulting materials can be suitably used as sound insulating materials such as vehicles interior materials and construction materials.

### DESCRIPTION OF THE PREFERRED EXAMPLES

The present invention will be hereinafter described using examples. Values measured by the following methods were adopted in evaluation.

(Average Fiber Diameter)

Scanning electron microscope photograph of nonwoven fabric was taken by a suitable magnification, and not less than 20 of fiber cross sections were measured, and an average thereof was calculated. When a sample of super fine fiber nonwoven fabric was a nonwoven fabric by melt blown method, since variation in diameter of fiber was large, not less than 100 of fiber cross sections were measured and an average thereof was calculated.

(Weight and Packing Density)

Nonwoven fabric was cut to 20 cm square, and a mass was measured. Resulting value was converted into a value per 1 m² to obtain a weight per unit of area. A weight of a nonwoven fabric was divided by a thickness of the nonwoven fabric under a load of 20 g/cm². Resulting value was converted into a value per g/cm³ to obtain a packing density.

(Frazier Air Permeability)

According to A method of JIS L-1096, measuring was carried out under a pressure loss of 12.7 mmAq.

(Breaking Elongation)

A sample nonwoven fabric was cut to a rectangle with a length of 20 cm, and a width of 5 cm. At room temperature of 25° C., low-speed tensile test with sample length of 10 cm, and crosshead 10 cm/minute was performed to obtain a breaking elongation.

(Sound Absorption Property)

A sound absorption property by a vertical incidence method was obtained according to JIS A-1405.

(Deep-drawing Local Strain)

1 cm×1 cm lattice design was printed or written on a sample. The sample was deep-drawing strained, and the local length of the sample after the strain was measured. The deep-drawing local strain was calculated based on the following formula:

Deep-drawing local strain (%)={(local length of the sample after the strain/local length of the sample before the strain)-1}×100

Also, the breaking and the shape of the sample were checked.

### Example 1

On a melt blown nonwoven fabric made of polyester elastomer (Pelprene by Toyobo Co., Ltd. P type) having average fiber diameter of 4 μm and weight of 60 g/m², a card web having a weight of 200 g/m² was laminated into crossed layer, which card web consists of 55% by mass of a recycled polyethylene terephthalate fiber having average fiber diameter of 27 μm, fiber length of 51 mm, and number of crimp of 12 crimps/inch, 15% by mass of a polyethylene terephthalate fiber having average fiber diameter of 14 μm, and 30% by mass of a conjugate fiber having a copolymerized polyester with average fiber diameter of 20 μm and with a melting point of 130° C. as a sheath component, and having a polyethylene terephthalate as a core component. Needle punch laminating processing was succeedingly carried out using the needle of No. 40, under conditions of a punching density of 20 perforations/cm², a penetration of needling of 10 mm. In order to avoid peeling problem, and to adjust thickness, heat treatment was applied to the laminated nonwoven fabric by an air through method to adjust the thickness thereof to 10 mm. Sound absorption property of obtained laminated nonwoven fabric is shown in Table 1. Since a breaking elongation of the nonwoven fabric was as large as 180%, it could be satisfactorily molded in a molding having about 50% of maximum drawing strain at 170° C., and an excellent edge of the molded body was given.

### Example 2

A commercially available polyethylene foam having an expansion ratio of 30 times and a thickness of 5 mm was laminated and adhered on a nonwoven fabric obtained in Example 1 with urethane based emulsion resin. A punching processing from both sides that uses needle punch needles of No. 42, and gives penetrated pores having about 0.2 mm diameter at the maximum in the shape of a lattice in 1.5 mm pitch had been beforehand given to the above-described foam. Frazier air permeability of the foam showed 0.2 cc/cm²·sec. When the obtained sound absorbing material is molded at 145° C., it could be molded satisfactorily in a molding having about 50% of maximum molding drawing strain. Sound absorption property was measured on a foamside. Measured data was shown in Table 1. Sound absorption performance was high and preferable.

### Example 3

To a nonwoven fabric obtained in Example 1, two sheets of punched foam used in Example 2 were laminated, and sound absorption performance was evaluated similarly. Thermally adhesive nonwoven fabric (tradename: Dynac LNS-3030) manufactured by Kureha Tech. was used for laminating two sheets. Sound absorption property was measured on the foam side. Measured data was shown in Table 1. Both of sound absorption performance and moldability were good.

### Example 4

On a spunbond nonwoven fabric (embossed area 26%) made of sheath core type conjugate fiber having a copolymerized polyester with a melting point of 150° C. as a sheath component and having a polyethylene terephthalate as a core component having average fiber diameter of 14 μm and weight of 60 g/m², a card web having a weight of 500 g/m² was laminated into crossed layer, which card web consists of 55% by mass of a recycled polyethylene terephthalate fiber having average fiber diameter of 27 μm, fiber length of 51 mm and number of crimp of 12 crimps/inch, 15% by mass of a polyethylene terephthalate fiber having average fiber diameter of 14 μm, and 30% by mass of a conjugate fiber having a copolymerized polyester with average fiber diameter of 20 μm and with a melting point of 130° C. as a sheath component, and having a polyethylene terephthalate as a core component. Needle punch laminating processing was succeedingly carried out using the needle of No. 40, under conditions of a punching density of 20 perforations/cm², a penetration of needling of 8 mm. In order to avoid peeling problem, and to adjust thickness, heat treatment was applied to the laminated nonwoven fabric by an air through method to adjust the thickness thereof to 25 mm. Sound absorption property of obtained laminated nonwoven fabric is shown in Table 1. Since a breaking elongation of the nonwoven fabric was as large as 180%, it could be satisfactorily molded in a molding having about 50% of maximum drawing strain at 170%, and an excellent edge of the molded body was given.

### Comparative Example 1

A needle punched nonwoven fabric that has a weight of 500 g/m², and has a thickness of 10 mm consisting of a polyethylene terephthalate staple fiber having average fiber diameter of 14 μm and having fiber length of 51 mm was prepared. Result of measured sound absorption property was shown in Table 1. Although the weight was higher compared with a sample in Example 1, sound absorption property was low. Also, in a molding at 170° C., breaking of fibers was observed in a deep drawing portion. Further, form stability after molding was bad.

### Comparative Example 2

A commercially available polyethylene foam used in Example 2 having a thickness of 5 mm, and an expansion ratio of 30 times was adhered to a nonwoven fabric obtained in Comparative Example 1. (Punching processing had not been given to this foam.) Result of measured sound absorption property was shown in Table 1. Although the weight of the laminated body was higher compared with a sample in Example 2, sound absorption property was low. Also, in a molding at 145° C., breaking of fibers was observed in a deep drawing portion. Further, form stability after molding was bad.

TABLE 1

| | Rate of sound absorption (%) | | | | | |
|---|---|---|---|---|---|---|
| Frequency | | | | | Comparative | Comparative |
| Hz | Example 1 | Example 2 | Example 3 | Example 4 | Example 1 | Example 2 |
| 630 | 8 | 9 | 33 | 35 | 7 | 4 |
| 800 | 18 | 19 | 56 | 47 | 18 | 7 |
| 1000 | 26 | 24 | 81 | 41 | 12 | 8 |
| 1250 | 37 | 40 | 90 | 75 | 23 | 13 |
| 1600 | 40 | 76 | 92 | 87 | 24 | 19 |
| 2000 | 49 | 80 | 94 | 87 | 39 | 31 |
| 2500 | 50 | 76 | 90 | 88 | 35 | 29 |
| 3150 | 66 | 72 | 83 | 92 | 51 | 41 |
| 4000 | 83 | 65 | 78 | 88 | 62 | 71 |

[Effect of the Invention]

A sound absorption material of the present invention has a high sound absorption performance, and it is a thin, lightweight, and excellent sound absorption material having excellent form stability, and also shows good moldability. Especially, in automotive applications, it may be used as a sound absorption material for improving fuel consumption, or comfortableness. In addition, it may be suitably used also as a sound absorption material for wide usage in industries.

What is claimed is:

1. A sound absorption material excellent in moldability, wherein a filament nonwoven fabric (A) having a weight of 20 to 200 g/m² and including fiber having a fiber diameter of not more than 15 μm and a staple fiber nonwoven fabric (B) having a weight of 50 to 2000 g/m² and a fiber diameter of 7 to 40 μm are laminated and integrated, and 5 to 50% by mass of the staple fiber nonwoven fabric (B) is a thermally adhesive fiber having a melting point of 100 to 190° C.

2. The sound absorption material excellent in moldability according to claim 1, wherein a fiber diameter of the fiber constituting the filament nonwoven fabric (A) is not more than 10 μm.

3. The sound absorption material excellent in moldability according to claim 1, wherein the fiber constituting the filament nonwoven fabric (A) is a super fine fiber, a fiber diameter of which is not more than 6 μm.

4. The sound absorption material excellent in moldability according to any one of claims 1 to 3, where in material of the filament nonwoven fabric (A) is a thermoplastic elastomer.

5. The sound absorption material excellent in moldability according to any one of claims 1 to 4, wherein a packing density of the staple fiber nonwoven fabric (B) is 0.005 to 0.3 g/cm³.

6. The sound absorption material excellent in moldability according to any one of claims 1 to 5, wherein the staple fiber nonwoven fabric (B) is prelaminated to the filament nonwoven fabric (A) by a needle punch method, and integrated by an air through method.

7. The sound absorption material excellent in moldability according to any one of claims 1 to 6, wherein a penetration of needling is 5 to 15 mm, and a punching density is 30 to 200 perforations/cm².

8. The sound absorption material excellent in moldability according to any one of claims 1 to 7, wherein a breaking elongation is not less than 25%.

9. The sound absorption material excellent in moldability according to any one of claims 1 to 8, wherein a filament nonwoven fabric (c) having a fiber diameter of 5 to 20 μm and a weight of 20 to 250 g/m² is laminated to at least one side of the sound absorption material.

10. The sound absorption material excellent in moldability according to any one of claims 1 to 8, wherein a foam consisting of polyolefin or polyester is laminated to at least one side of the sound absorption material.

11. The sound absorption material excellent in moldability according to claim 10, wherein Frazier air permeability of the foam is not more than 6 cc/cm²·sec.

12. The sound absorption material excellent in moldability according to any one of claims 1 to 11, wherein a deep-drawing local strain is 40% or more.

13. The sound absorption material excellent in moldability according to any one of claims 1 to 12, wherein the sound absorption material is interior material for vehicles.
